(19) United States
(12) Patent Application Publication
(10) Pub. No.: US 2016/0004118 A1
(43) Pub. Date: Jan. 7, 2016

(54) LIQUID CRYSTAL DISPLAY APPARATUS

(71) Applicant: SHARP KABUSHIKI KAISHA, Osaka-shi, Osaka (JP)

(72) Inventors: Takeshi IKEDA, Osaka-shi (JP); Naoya OBUCHI, Osaka-shi (JP); Kenichi SUWA, Osaka-shi (JP)

(73) Assignee: SHARP KABUSHIKI KAISHA, Osaka-shi, Osaka (JP)

(21) Appl. No.: 14/765,751

(22) PCT Filed: Feb. 4, 2014
(86) PCT No.: PCT/JP2014/052522

§ 371 Date: Aug. 4, 2015

(30) Foreign Application Priority Data
Feb. 5, 2013 (JP) 2013-020524

(51) Int. Cl. G02F 1/1333

(52) U.S. Cl. CPC G02F 1/133308; G02F 2001/13332

(57) ABSTRACT

A liquid crystal display apparatus includes a liquid crystal display unit including a screen on a front side thereof, a front cabinet that has a rectangular frame-like shape and that covers a peripheral front edge and a peripheral side portion of the liquid crystal display unit, and a fixing device that fixes the liquid crystal display unit and the front cabinet to each other. The front cabinet includes a rib on an inner surface thereof facing the peripheral side portion of the liquid crystal display unit, the rib extending along a periphery of the front cabinet. The fixing device has a slit that is hooked to the rib. The liquid crystal display apparatus includes a prevention portion for preventing displacement of the fixing device.

### CROSS-REFERENCE TO RELATED APPLICATIONS

This application is the National Phase of PCT/JP2014/052522 filed on Feb. 4, 2014, which claims priority under 35 U.S.C. 119(a) to Patent Application No. 2013-020524 filed in Japan on Feb. 5, 2013, all of which are hereby expressly incorporated by reference into the present application.

### FIELD

The present application relates to a liquid crystal display apparatus including a fixing device for fixing components to each other.

### BACKGROUND

To facilitate the operation of assembling liquid crystal display apparatuses, a method of fixing a front cabinet of a liquid crystal display apparatus and a liquid crystal panel module to each other by using a short angular fixing device is used (see, for example, Japanese Unexamined Patent Application Publication No. 2009-58915).

In such a case, a rib is formed on an inner surface of the front cabinet facing a peripheral side portion of the liquid crystal panel module, and a slit, which is hooked to the rib, is formed in a side portion of the fixing device. By sliding the fixing device in a direction in which the rib extends, the slit of the fixing device is hooked to the rib of the front cabinet. The other side portion of the fixing device is brought into contact with a peripheral back edge of the liquid crystal panel module.

### SUMMARY

The fixing device is attached to the front cabinet by hooking the slit to the rib. Therefore, if an operator accidentally touches the fixing device in a state in which the fixing device is attached to the front cabinet, the fixing device may become displaced and the operation efficiency may decrease.

The present application has been made against such a background. An object of the present application is to provide a liquid crystal display apparatus that can prevent displacement of a fixing device hooked to a front cabinet.

A liquid crystal display apparatus according to the present application includes a liquid crystal display unit including a screen on a front side thereof, a front cabinet that has a rectangular frame-like shape and that covers a peripheral front edge and a peripheral side portion of the liquid crystal display unit, and a fixing device that fixes the liquid crystal display unit and the front cabinet to each other. The front cabinet includes a rib on an inner surface thereof facing the peripheral side portion of the liquid crystal display unit, the rib extending along a periphery of the front cabinet. The fixing device has a slit that is hooked to the rib. The liquid crystal display apparatus includes a prevention portion for preventing displacement of the fixing device.

The liquid crystal display apparatus according to the present application includes the front cabinet having a rectangular frame-like shape, the liquid crystal display unit covered by the front cabinet, and the fixing device that fixes the front cabinet and the liquid crystal display unit to each other. The front cabinet includes the rib on the inner surface thereof facing the peripheral side portion of the liquid crystal display unit, the rib extending along the periphery of the front cabinet. The fixing device has the slit that is hooked to the rib. The liquid crystal display apparatus includes the prevention portion for preventing displacement of the fixing device.

Thus, even if a force is applied from the outside to the fixing device attached to the front cabinet, the position of the fixing device does not become displaced.

In the liquid crystal display apparatus according to the present application, the fixing device has a short angular shape and includes a contact portion that is one side portion thereof, the contact portion being in contact with the inner surface of the front cabinet and having the slit; and the prevention portion is the contact portion, whose peripheral edge portion near an open end of the slit is curved in a direction in which the peripheral edge portion approaches the front cabinet.

In the liquid crystal display apparatus according to the present application, the fixing device has a short angular shape. The fixing device includes the contact portion that is one side portion thereof, the contact portion being in contact with the inner surface of the front cabinet and having the slit. The prevention portion for preventing displacement of the fixing device is the contact portion, whose peripheral edge portion near the open end of the slit is curved in the direction in which the peripheral edge portion approaches the front cabinet.

Thus, if the contact portion is inserted into a gap between the front cabinet and the liquid crystal display unit, the fixing device is urged by the front cabinet and the liquid crystal display unit with an elastic force generated by the contact portion, and therefore the fixing device does not become displaced even if a force is applied to the fixing device from the outside.

In the liquid crystal display apparatus according to the present application, a boss stands on a peripheral back edge of the liquid crystal display unit, and the fixing device includes a cover portion that is the other side portion thereof, the cover portion covering the peripheral back edge of the liquid crystal display unit; and the prevention portion is a protrusion that is disposed at an end of the cover portion in a direction along the periphery of the front cabinet so as to protrude toward a back side of the liquid crystal display unit.

In the liquid crystal display apparatus according to the present application, the boss stands on the peripheral back edge of the liquid crystal display unit. The fixing device includes the cover portion that is the other side portion thereof, the cover portion covering the peripheral back edge of the liquid crystal display unit. The prevention portion is a protrusion that is disposed at an end of the cover portion in the direction along the periphery of the front cabinet. The protrusion protrudes toward the back side of the liquid crystal display unit.

Thus, even when the fixing device is moved, the fixing device does not become displaced by a large amount because the protrusion contacts the boss.

In the liquid crystal display apparatus according to the present application, a width of the slit increases toward an open end of the slit.

In the liquid crystal display apparatus according to the present application, the width of the slit increases toward the open end of the slit. Thus, when hooking the rib to the slit, the open end of the slit can function to allow the rib to be easily inserted into the slit.

In the liquid crystal display apparatus according to the present application, the cover portion has a through-hole for fixing the cover portion to the liquid crystal display unit, and the boss stands at a position corresponding to the through-hole.

In the liquid crystal display apparatus according to the present application, the cover portion has the through-hole for fixing the cover portion to the liquid crystal display unit. The boss of the liquid crystal display unit protrudes from the position corresponding to the through-hole of the attached fixing device.

Thus, the fixing device is fixed to liquid crystal display unit by inserting a screw into the through-hole and screwing the screw into the boss.

In the liquid crystal display apparatus according to the present application, the fixing device has a short angular shape and includes a contact portion that is one side portion thereof, the contact portion being in contact with the inner surface of the front cabinet and having the slit therein. The contact portion has a hole for fixing the contact portion to the front cabinet. The rib includes an engagement portion that is disposed at an end thereof and that is capable of being engaged with the contact portion and a projection that is disposed at a part of the engagement portion facing the contact portion. The prevention portion is the hole and the projection, which are fitted to each other.

In the liquid crystal display apparatus according to the present application, the fixing device has a short angular shape. The fixing device includes the contact portion that is one side portion thereof, the contact portion being in contact with the inner surface of the front cabinet and having the slit therein. The contact portion has the hole for fixing the contact portion to the front cabinet. The rib includes the engagement portion that is disposed at an end thereof and that is capable of being engaged with the contact portion and the projection that is disposed at a part of the engagement portion facing the contact portion. The prevention portion for preventing displacement of the fixing device is the hole and the projection, which are fitted to each other.

Thus, by fitting the projection and the hole to each other, the fixing device is fixed to the front cabinet and does not become displaced. The operator can check that the fixing device is attached to the front cabinet by hearing a sound that is made when the projection and the hole are fitted to each other.

In the liquid crystal display apparatus according to the present application, the hole has a diameter larger than a width of the slit and is disposed at a far end of the slit so as to overlap the slit.

In the liquid crystal display apparatus according to the present application, the hole has a diameter larger than the width of the slit. The hole is disposed at the far end of the slit so as to overlap the slit.

Thus, the slit and the hole can be simultaneously formed.

In the liquid crystal display apparatus according to the present application, the boss is a swage boss.

In the liquid crystal display apparatus according to the present application, the boss is the swage boss.

In the liquid crystal display apparatus according to the present application, the fixing device is made of a metal.

In the liquid crystal display apparatus according to the present application, the fixing device is made of a metal.

Thus, the strength of the fixing device and the connectivity between the front cabinet and the liquid crystal display unit can be ensured.

A television set according to the present application includes the liquid crystal display apparatus and a receiver for receiving a telecast and displays an image in accordance with the telecast received by the receiver.

The television set according to the present application includes the liquid crystal display apparatus and the receiver for receiving a telecast. The liquid crystal display unit displays an image in accordance with the telecast received.

According to an aspect of the present application, displacement of the fixing device hooked to the front cabinet can be prevented.

The above and further objects and features will more fully be apparent from the following detailed description with accompanying drawings.

### BRIEF DESCRIPTION OF THE DRAWINGS

FIG. 1 is a front perspective view of a television set.

FIG. 2 is a partial side sectional view of an upper part of the television set.

FIG. 3 is a rear view of the television set in a state in which a back cabinet is removed.

FIG. 4 is a perspective view of an angle bracket.

FIG. 5 illustrates the angle bracket as viewed in a direction perpendicular to a contact portion.

FIG. 6 illustrates the angle bracket as viewed in a direction perpendicular to a cover portion.

FIG. 7 illustrates a state before the angle bracket is attached to the front cabinet and a liquid crystal panel module.

FIG. 8 illustrates a state in which the angle bracket is being attached to the front cabinet and the liquid crystal panel module.

FIG. 9 is a perspective view of a rib.

FIG. 10 is a perspective view of an angle bracket.

FIG. 11 is a perspective view of a rib.

FIG. 12 is a perspective view of an angle bracket.

### DETAILED DESCRIPTION

Examples of a liquid crystal display apparatus according to an embodiment of the present application include a monitor that is used by being connected to a television set, an electronic whiteboard, or a tuner; a monitor that is used by being connected to a desktop computer; and a display that is used as digital signage. Examples of a liquid crystal display apparatus according to an embodiment of the present application further include a display that is used for a tablet computer, a PDA (Personal Digital Assistant), or a mobile phone. Hereinafter, an example of the liquid crystal display apparatus will be described on the basis of drawing of an embodiment that is used for a television set.

### First Embodiment

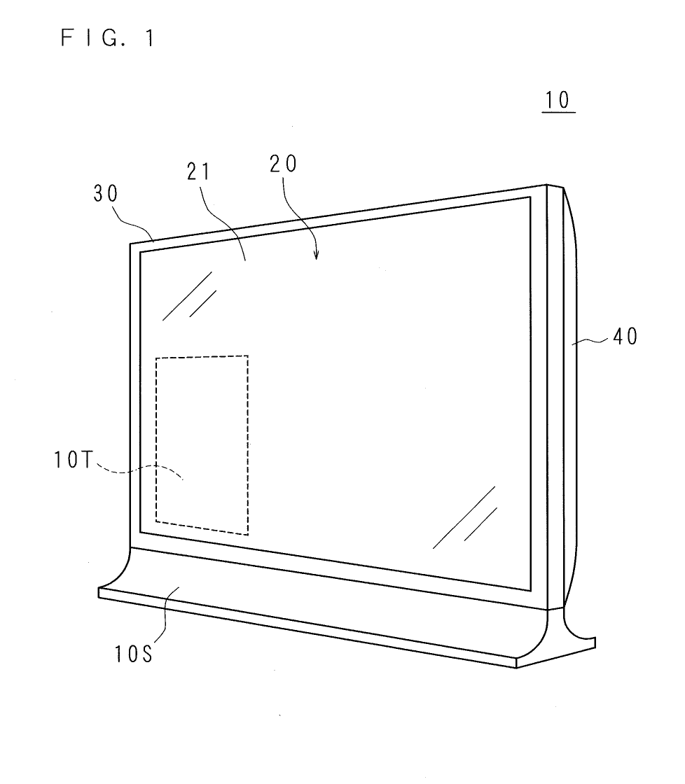

FIG. 1 is a front perspective view of a television set 10. In a state in which a viewer faces a screen 21 on which the television set 10 in an upright position displays an image, a side from the screen 21 toward the viewer is defined as a forward side or a front side, and a side opposite to this side is defined as a backward side or a back side. The screen 21 has a horizontally elongated rectangular shape. From the viewpoint of a viewer facing the screen 21, the right side along the long side of the screen 21 is defined as the right side of the television set 10, and the left side along the long side of the screen 21 is defined as the left side of the television set 10. The upper side along the short side of the screen 21 is defined as the upper side of the television set 10, and the lower side along the short side of the screen 21 is defined as the lower side of the television set 10.

The television set 10 includes a liquid crystal panel module (liquid crystal display unit) 20, a front cabinet 30, a back cabinet 40, a stand 10S, and a tuner (receiver) 10T.

The liquid crystal panel module 20 is a functional unit including a liquid crystal panel having a resolution four times the resolution of Hi-Vision, an optical sheet, a direct backlight, a reflection sheet, and the like. The liquid crystal panel has the screen 21 on the front side thereof, is irradiated with light emitted from the backlight from behind, and displays a television image on the screen 21.

The front cabinet 30 is a part of a housing including a front side and a peripheral side of the television set 10. The front cabinet 30 is also a frame that is made of aluminum, a synthetic resin, or the like and that covers a peripheral front edge and a peripheral side portion of the liquid crystal panel module 20.

The back cabinet 40 is a part of the housing including a back side of the television set 10. The back cabinet 40 is made of, for example, a synthetic resin and has a substantially rectangular tray-like shape protruding toward the back side.

The stand 10S is a base that supports the television set 10 in an upright position on the floor. The shape of the stand 10S in a side view is like a gently sloped mountain. The three-dimensional shape of the stand 10S is such that the stand 10S extends in the left-right direction with a uniform sectional shape in side sectional view. A bottom portion of the stand 10S, which is in contact with the floor, has a rectangular shape. The width of the bottom portion is substantially the same as that of the front cabinet 30 and the back cabinet 40. The depth of the bottom portion is larger than that of the front cabinet 30 and the back cabinet 40. The television set 10 can be mounted on a wall in a room by using a metal mount. In this case, the stand 10S is removed from the television set 10.

The tuner 10T selectively receives a telecast signal, converts the received signal into an intermediate frequency signal, and outputs the intermediate frequency signal.

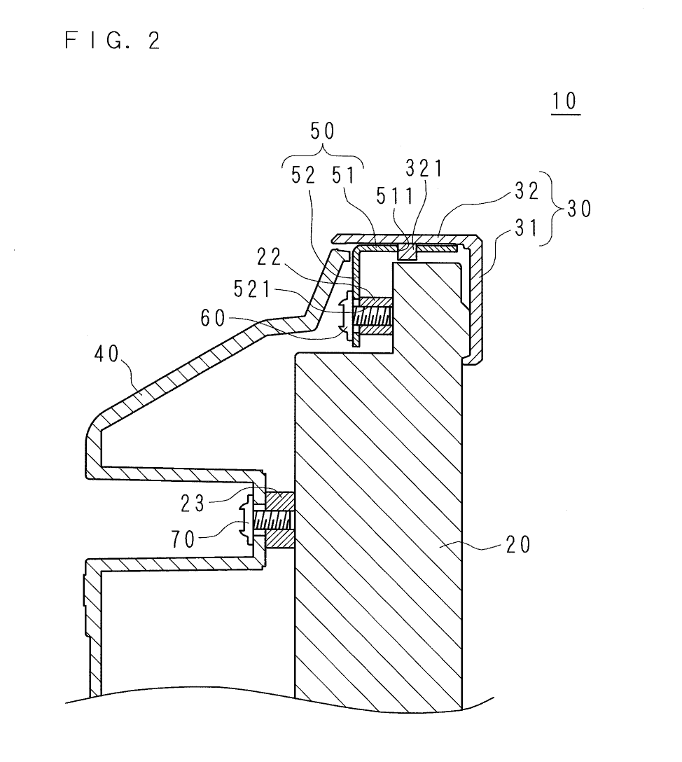

FIG. 2 is a partial side sectional view of an upper part of the television set 10. The right side in FIG. 2 corresponds to the front side of the television set 10, and the left side in FIG. 2 corresponds to the back side of the television set 10.

The front cabinet 30 is a frame that is L-shaped in a side sectional view and includes a front portion 31 and a side portion 32. The front portion 31 covers a peripheral front edge of the liquid crystal panel module 20. The side portion 32 covers a peripheral side portion of the liquid crystal panel module 20. At substantially the center of an inner surface of the side portion 32, a plurality of ribs 321 stand along a periphery of the front cabinet 30.

The liquid crystal panel module 20 and the front cabinet 30 of the television set 10 are fixed to each other by using a metal fixing device having a short angular shape. Hereinafter, the metal fixing device will be referred to as an angle bracket (fixing device) 50. The angle bracket 50 includes a contact portion (prevention portion) 51 and a cover portion 52.

The contact portion 51 is one side portion of the angle bracket 50 that comes into contact with the inner surface of the side portion 32 of the front cabinet 30.

The cover portion 52 is the other side portion of the angle bracket 50 that covers the peripheral back edge of the liquid crystal panel module 20 in a state in which the cover portion 52 is separated from the peripheral back edge. The cover portion 52 has a through-hole 521 into which a screw 60 can be inserted. By screwing the screw 60 into a swage boss (boss) 22, which stands on the peripheral back edge of the liquid crystal panel module 20, the cover portion 52 is fixed to the liquid crystal panel module 20.

A boss 23 is disposed on the back surface of the liquid crystal panel module 20. A recess, which is recessed toward the front side, is formed in a part of the back cabinet 40 corresponding to the boss 23. A screw hole, into which a screw 70 is inserted, is formed in a bottom portion of the recess. The back cabinet 40 is fixed to the liquid crystal panel module 20 by inserting the screw 70 through the screw hole and by screwing the screw 70 into the boss 23.

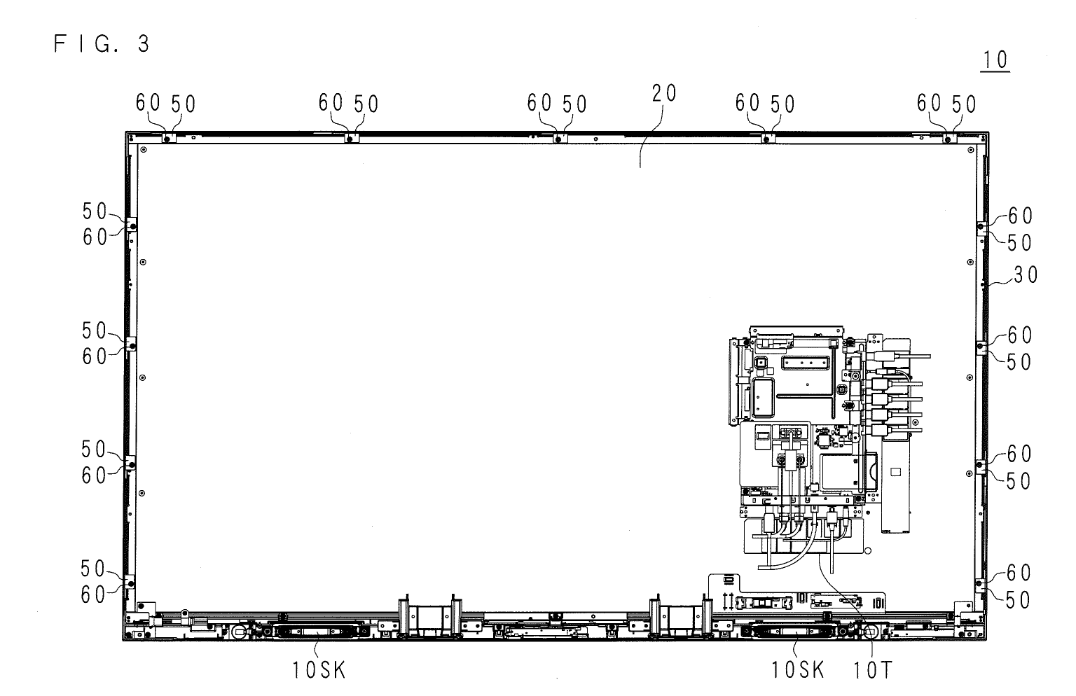

FIG. 3 is a rear view of the television set 10 in a state in which the back cabinet 40 and the stand 10S are removed. The liquid crystal panel module 20 and the front cabinet 30 are fixed to each other by using, for example, thirteen angle brackets 50. In the example shown in FIG. 3, five angle brackets 50 are arranged along the upper edge of the front cabinet 30 and the liquid crystal panel module 20 at substantially regular intervals. In the example shown in FIG. 3, four angle brackets 50 are arranged along each of the left and right edges of the front cabinet 30 and the liquid crystal panel module 20 at substantially regular intervals. In the example shown in FIG. 3, many components (such as speakers 10SK) are disposed in the bottom portion of the television set 10. Therefore, the angle bracket 50 is not disposed along the lower edge of the front cabinet 30 and the liquid crystal panel module 20.

In general, the angle bracket 50 may be disposed along one, two, three, or four of the four edges of the front cabinet 30 and the liquid crystal panel module 20.

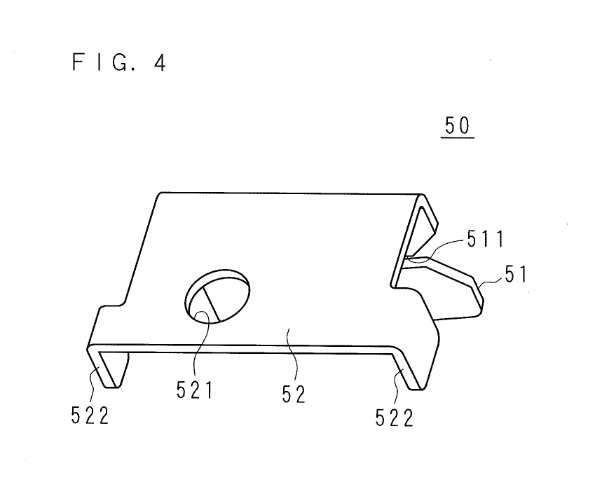

FIG. 4 is a perspective view of the angle bracket 50. The contact portion 51 and the cover portion 52 are both rectangular plates. The contact portion 51 and the cover portion 52 intersect each other substantially at right angles. The angle bracket 50 is attached to the front cabinet 30 and the liquid crystal panel module 20 in such a way that the contact portion 51 is in contact with the side portion 32 of the front cabinet 30 and the cover portion 52 covers the peripheral back edge of the liquid crystal panel module 20.

The contact portion 51 has a slit 511 to be hooked to the rib 321 of the front cabinet 30. When the slit 511 is hooked to the rib 321, the contact portion 51 is fixed to the side portion 32 of the front cabinet 30. When hooking the slit 511 to the rib 321, the angle bracket 50 is slid along the periphery of the front cabinet 30 (in a direction perpendicular to the plane of FIG. 2).

Two corners at the edge of the contact portion 51, which face each other with an open end of the slit 511 therebetween, are chamfered at an angle of about 45 degrees with respect to the direction in which the slit 511 extends (which is substantially the same as the direction along the periphery of the front cabinet 30). Therefore, the width of the slit 511 increases toward the open end. Thus, the rib 321 can be easily inserted into the slit 511 when the angle bracket 50 is slid along the periphery of the front cabinet 30 so as to hook the slit 511 to the rib 321 to attach the angle bracket 50 to the front cabinet 30.

Only one of the corners of the edge of the contact portion 51 may be chamfered. The chamfer angle at the corner of the edge of the contact portion 51 is not limited to 45 degrees. The corner of the edge of the contact portion 51 may be chamfered in a round shape.

When the angle bracket 50 is slid and an end portion of the rib 321 contacts the far end of the slit 511, the angle bracket 50 is moved to a position beyond which the angle bracket 50 cannot be slid. When the angle bracket 50 is moved to this position, the through-hole 521 is positioned so as to be located above the swage boss 22.

A protrusion (prevention portion) 522 is disposed at each of two end portions of the cover portion 52 in the direction in which the angle bracket 50 is slid. When the angle bracket 50 is attached to the front cabinet 30 and the liquid crystal panel module 20, the protrusions 522 protrude toward the back side of the liquid crystal panel module 20. The direction in which the protrusions 522 protrude is substantially the same as the direction in which the swage boss 22 protrudes.

The protrusions 522 of the angle bracket 50 of FIG. 4 are formed by bending, inwardly at substantially the right angles, protrusions extending from the two end portions of the cover portion 52 in the direction in which the angle bracket 50 is slid. In other words, in a state in which the angle bracket 50 is attached to the front cabinet 30 and the liquid crystal panel module 20, the protrusions 522 are bent toward the front side of the television set 10.

The protrusions 522 may be formed in the angle bracket 50 by using a method other than bending. For example, the protrusion 522 may be formed in the angle bracket 50 by crimping, welding, or bonding using an adhesive.

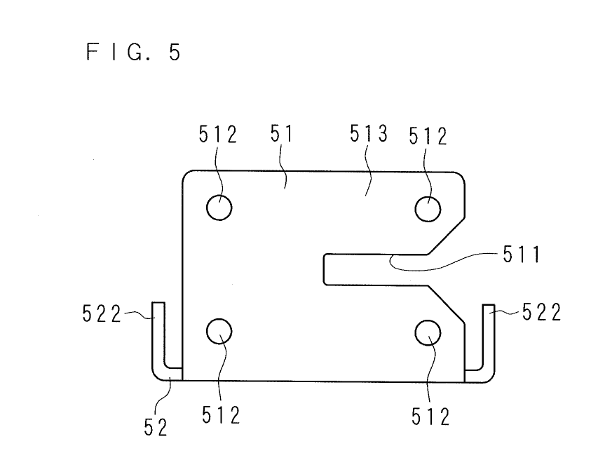

FIG. 5 illustrates the angle bracket 50 as viewed in a direction perpendicular to the contact portion 51. In the state shown in FIG. 5, the cover portion 52 and the protrusions 522 extend from the contact portion 51 in a direction toward the back side of the plane of FIG. 5.

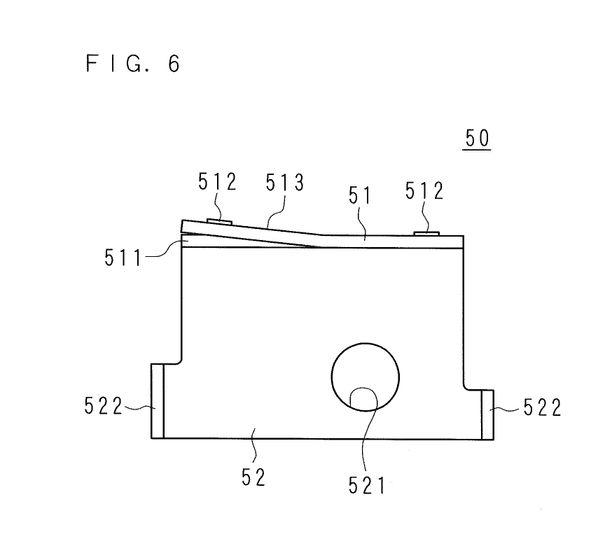

FIG. 6 illustrates the angle bracket 50 as viewed in a direction perpendicular to the cover portion 52. In the state shown in FIG. 6, the contact portion 51 and the protrusions 522 extend from the cover portion 52 in a direction toward the front side of the plane of FIG. 6.

Thin disk-shaped projections 512 are disposed at four corners of the outer surface of the contact portion 51. When the angle bracket 50 is slid along the front cabinet 30, the disk-shaped projections 512 slide along the inner surface of the side portion 32 on both sides of the rib 321, and the slit 511 is hooked to the rib 321.

The contact portion 51 includes a curved portion 513. The curved portion 513 is a part of the contact portion 51 that is on a side of the slit 511 toward which the protrusions 522 protrude and that is near the open end of the slit 511. When the angle bracket 50 is attached to the front cabinet 30, the curved portion 513 is bent at substantially the center of the contact portion 51 at an angle of, for example, six degrees with respect to the in-plane direction of the contact portion 51 in a direction in which the curved portion 513 approaches the front cabinet 30. The direction in which the curved portion 513 approaches the front cabinet 30 is the same as a direction toward the outside of the television set 10.

Next, a method of assembling the television set 10 will be described.

The front cabinet 30 is placed on a substantially horizontal table with the back side of the front cabinet 30 facing up. The liquid crystal panel module 20 is placed at a predetermined position on the front cabinet 30 with the back side of the liquid crystal panel module 20 facing up.

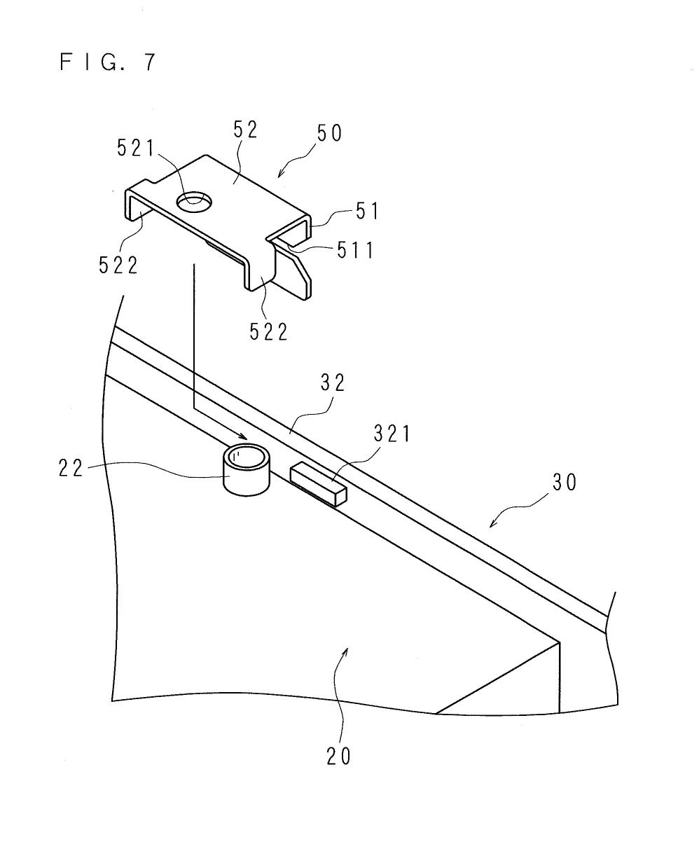

FIG. 7 illustrates a state before the angle bracket 50 is attached to the front cabinet 30 and the liquid crystal panel module 20. In FIG. 7, the direction in which the angle bracket 50 is moved is indicated by an arrow.

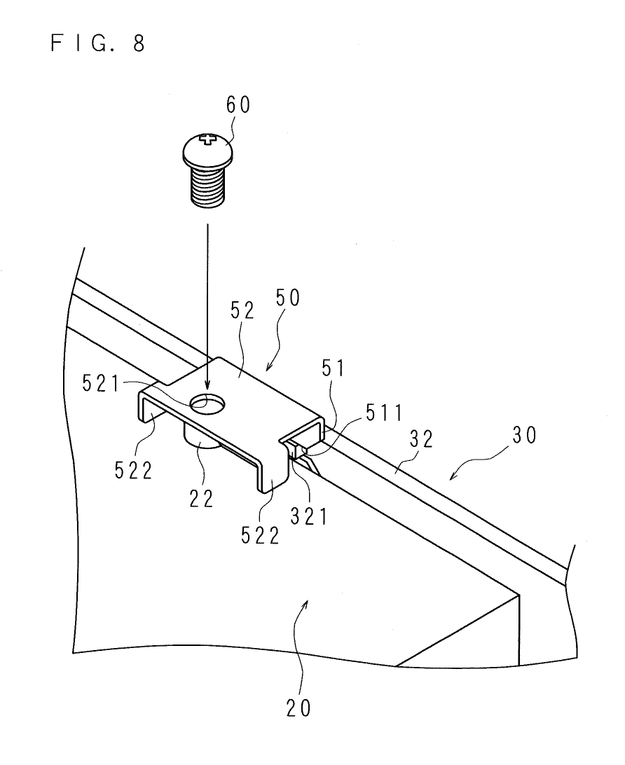

FIG. 8 illustrates a state in which the angle bracket 50 is being attached to the front cabinet 30 and the liquid crystal panel module 20. In FIG. 8, the direction in which the screw 60 is moved is indicated by an arrow.

The position of the angle bracket 50 is adjusted so that the contact portion 51 of the angle bracket 50 becomes substantially parallel to the side portion 32 of the front cabinet 30 and the cover portion 52 becomes substantially parallel to the back surface of the liquid crystal panel module 20. The contact portion 51 of the angle bracket 50 is inserted from above into a gap between the side portion 32 of the front cabinet 30 and the liquid crystal panel module 20. At this time, the angle bracket 50 is disposed at a position at which the cover portion 52 between the protrusions 522 faces the swage boss 22. For the number of the angle brackets 50 needed to assemble the television set 10, the angle brackets 50 are arranged as described above along the peripheral edge of the front cabinet 30 and the liquid crystal panel module 20.

Next, the angle bracket 50 is started to be slid along the periphery of the front cabinet 30 so as to insert the rib 321 on the inner surface of the side portion 32 into the slit 511 of the contact portion 51. The angle bracket 50 is slid to a position at which the through-hole 521 overlaps the swage boss 22. At this time, the curved portion 513 of the contact portion 51 is in contact with the side portion 32 of the front cabinet 30, and parts of the contact portion 51 other than the curved portion 513 are in contact with the liquid crystal panel module 20. Therefore, the curved portion 513 pushes back the side portion 32 of the front cabinet 30 with a restoring force due to elastic deformation. Likewise, the parts other than the curved portion 513 push back the liquid crystal panel module 20 with a restoring force due to elastic deformation. As a result, the angle bracket 50, which has been inserted into the gap between the side portion 32 of the front cabinet 30 and the liquid crystal panel module 20, receives an urging force from the front cabinet 30 and the liquid crystal panel module 20. Therefore, the angle bracket 50, which has been slid to the fixed position, is not easily moved even if the angle bracket 50 is accidentally pressed by an assembly operator.

Let it be assumed that a large force is applied to the angle bracket 50 slid to the fixed position and the angle bracket 50 is moved from the fixed position in a direction opposite to the sliding direction. Even in such a case, the angle bracket 50 does not become considerably displaced from the fixed position, because the inner surface of the protrusion 522 comes into contact with the swage boss 22.

The swage boss 22 and the through-hole 521 may be structured so as to be fitted to each other. If an end of the swage boss 22 is fitted into the through-hole 521 when the angle bracket 50 is slid to the fixed position, the swage boss 22 can prevent the angle bracket 50 from being moved from the fixed position.

The angle brackets 50 are slid to the fixed positions a number of times the same as the number of the angle brackets 50 to be arranged along the peripheral edge of the front cabinet 30 and the liquid crystal panel module 20. When all of the angle brackets 50 have been slid, for each of the angle brackets 50, the screw 60 is inserted from above into the through-hole 521 and screwed into the screw hole in the swage boss 22.

A circuit board, including the tuner 10T, and the like are mounted on the back surface of the liquid crystal panel module 20. The back cabinet 40 is placed from above on the back side of the front cabinet 30 and the liquid crystal panel module 20 (see FIG. 2). The screw 70 is screwed into the screw hole of the boss 23 of the liquid crystal panel module 20 to fix the back cabinet 40 and the liquid crystal panel module 20 to each other. Thus, assembly of the television set 10 is finished.

In a case where the front cabinet 30 is made by, for example, extrusion, a portion to become the rib 321 is initially formed as a rail-shaped portion. Subsequently, the rib 321 is formed by, for example, cutting one or more parts of the rail-shaped portion.

With the television set 10, displacement of the angle bracket 50, which fixes the liquid crystal panel module 20 and the front cabinet 30 to each other, can be prevented.

If an operator accidentally touches the angle bracket 50 in a state in which the angle bracket 50 has been attached to the front cabinet 30, the angle bracket 50 may become displaced from the position at which the angle bracket 50 is to be fixed with the screw 60. However, because the contact portion 51 includes the curved portion 513, the contact portion 51 is urged by the liquid crystal panel module 20 and the front cabinet 30, and therefore displacement does not easily occur even if a force is applied to the angle bracket 50 from the outside. This has an effect of suppressing a decrease in the efficiency of assembling the television set 10. Moreover, even if the angle bracket 50 is moved from the fixed position, the movement of the angle bracket 50 is restricted because the protrusion 522 contacts the swage boss 22, so that the angle bracket 50 does not become considerably displaced from the fixed position.

### Second Embodiment

A second embodiment is an embodiment with which displacement of an angle bracket 50 is prevented by fitting a projection (prevention portion) formed on a front cabinet 30 into a hole (prevention portion) formed in the angle bracket 50.

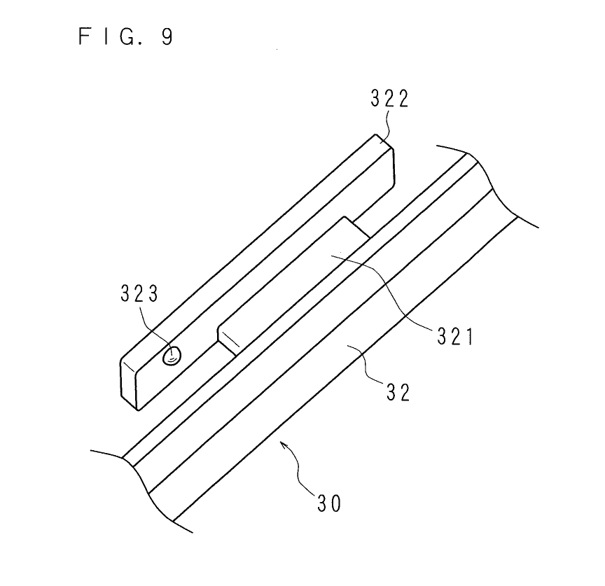

FIG. 9 is a perspective view of a rib 321. An engagement portion 322, which has a rectangular plate-like shape, is joined to an end of the rib 321. The size of the engagement portion 322 is larger than that of a slit 511 of the angle bracket 50, and the engagement portion 322 can engage with the angle bracket 50 that moves toward the inside of the television set 10. A semispherical projection (prevention portion) 323 is formed on the outer surface of the engagement portion 322, which faces the angle bracket 50 when the slit 511 of the angle bracket 50 is hooked to the rib 321. The projection 323 is formed on a region of the engagement portion 322 that is on a side in a direction in which the angle bracket 50 is slid and that is outside of a position to which the rib 321 extends in the direction.

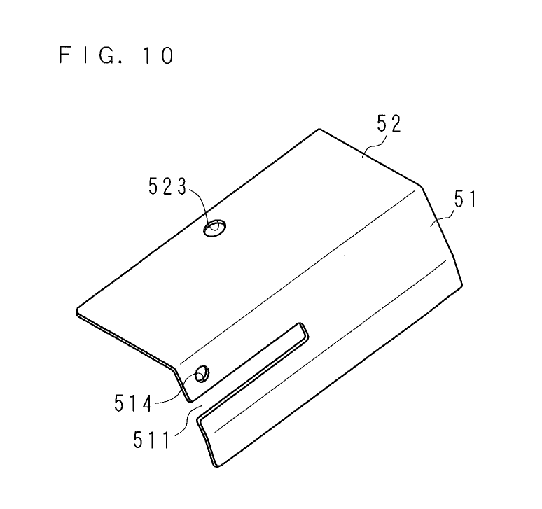

FIG. 10 is a perspective view of the angle bracket 50. A hole 514, into the projection 323 of FIG. 9 can be fitted when the angle bracket 50 is slid and the rib 321 is hooked to the slit 511, is formed in a contact surface 51 of the angle bracket 50. The hole 514 may be a through-hole or may be a recess that does not extend through the contact portion 51. In the example shown in FIG. 10, the hole 514 is a through-hole. When the projection 323 is fitted into the hole 514, the angle bracket 50 is securely fixed to the front cabinet 30 and displacement does not occur. The projection 323 and the hole 514 are structured so as to make a sound, such as a click sound, when the angle bracket 50 is slid and the rib 321 becomes hooked to the slit 511 and the projection 323 is fitted into the hole 514. Thus, an operator assembling the television set 10 can check that the angle bracket 50 is securely attached to the front cabinet 30.

A screw insertion hole 523 is formed in a cover portion 52 of the angle bracket 50. A screw 60 is inserted into the screw insertion hole 523 from the back side, and the inserted screw 60 is screwed into a swage boss 22 of a liquid crystal panel module 20, which is located in front of the screw insertion hole 523. Thus, the angle bracket 50 is fixed to the liquid crystal panel module 20.

By using the screw insertion hole 523 and the swage boss 22, the back cabinet 40, the angle bracket 50, and the liquid crystal panel module 20 may be fixed to each other with the screw 60.

Alternatively, a part of the cover portion 52 around the screw insertion hole 523 may be made to protrude toward the back side by, for example, extrusion, and a threaded burring tap hole may be formed at the position of the screw insertion hole 523. Thus, the angle bracket 50 may be screw-fixed to the back cabinet 40.

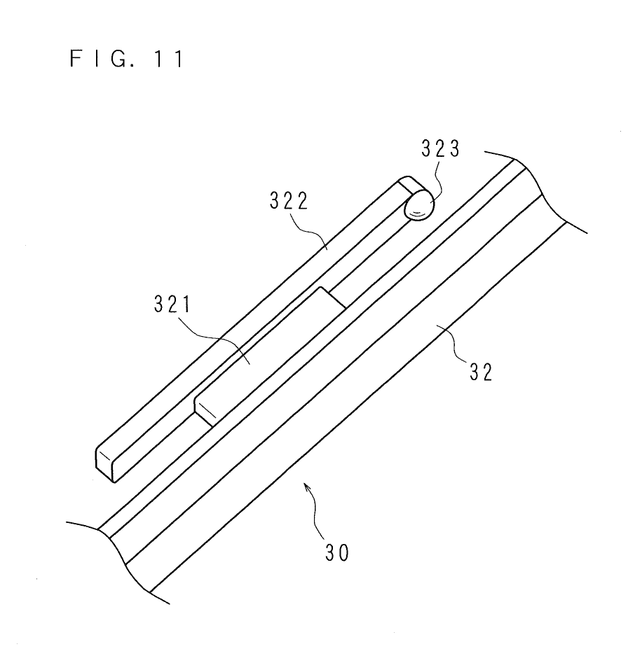

FIG. 11 is a perspective view of a rib 321.

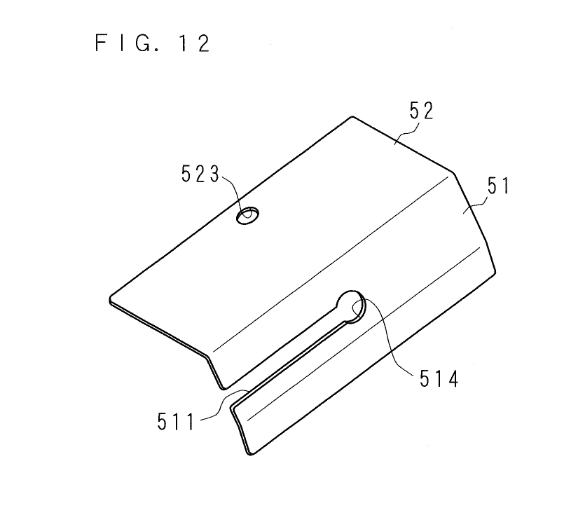

FIG. 12 is a perspective view of an angle bracket 50.

FIGS. 11 and 12 illustrate other examples of an engagement portion 322 and the angle bracket 50 according to the second embodiment.

The engagement portion 322, which has an elongated rectangular plate-like shape extending in a direction in which the rib 321 extends, is joined to an end of the rib 321. The size of the engagement portion 322 is larger than that of a slit 511 of the angle bracket 50, and the engagement portion 322 can engage with the angle bracket 50 that moves toward the inside of the television set 10. A semispherical projection (prevention portion) 323 is formed on the outer surface of the engagement portion 322, which faces the angle bracket 50 when the slit 511 of the angle bracket 50 is hooked to the rib 321. The projection 323 is disposed at an end of the engagement portion 322 on a side in a direction opposite to the direction in which the angle bracket 50 is slid.

The diameter of a hole 514 in the contact portion 51 is larger than the width of the slit 511. The hole 514 is a through-hole that is formed in at a far end of the slit 511 so as to overlap the slit 511. When the angle bracket 50 is slid and the rib 321 becomes hooked to the slit 511, a sound, such as a click sound is made and the projection 323 is fitted into the hole 514. Thus, an operator assembling the television set 10 can fix the angle bracket 50 to the front cabinet 30 so as not to become displaced and check that the angle bracket 50 is fixed to the front cabinet 30.

With the television set 10, displacement of the angle bracket 50, which fixes the liquid crystal panel module 20 and the front cabinet 30 to each other, can be prevented.

When the angle bracket 50 is slid and the rib 321 is hooked to the slit 511 of the angle bracket 50, the projection 323 of the engagement portion 322, which is disposed at an end of the rib 321, makes a sound and is fitted into the hole 514 of the contact portion 51. The cover portion 52 of the angle bracket 50 becomes engaged with the engagement portion 322, and movement of the angle bracket 50 toward the inside of the television set 10 is restricted. Thus, displacement of the angle bracket 50 can be prevented, and an operator assembling the television set 10 can check that the angle bracket 50 is fixed to the front cabinet 30 by hearing the sound.

The second embodiment is described above and other elements thereof are the same as those of the first embodiment. Therefore, corresponding elements are denoted by the same numerals and the detailed descriptions of such elements are omitted.

The embodiments disclosed herein are exemplary in all respects and should not be considered limiting. The scope of the present invention is not represented by the above description but is represented by the claims and it is intended that any modifications are included within the scope of the claims and the equivalents thereof.

Technical features (elements) described in the embodiments may be used in combination and a new technical features can be formed by combining the technical features.

1-5. (canceled)

6. A liquid crystal display apparatus comprising:
a liquid crystal display unit including a screen on a front side thereof;
a front cabinet that has a rectangular frame-like shape and that covers a peripheral front edge and a peripheral side portion of the liquid crystal display unit; and
a fixing device that fixes the liquid crystal display unit and the front cabinet to each other,
wherein the front cabinet includes a rib on an inner surface thereof facing the peripheral side portion of the liquid crystal display unit, the rib extending along a periphery of the front cabinet,
wherein the fixing device has a slit that is hooked to the rib, and
wherein the liquid crystal display apparatus includes a prevention portion for preventing displacement of the fixing device.

7. The liquid crystal display apparatus according to claim 6,
wherein the fixing device has a short angular shape and includes a contact portion that is one side portion thereof, the contact portion being in contact with the inner surface of the front cabinet and having the slit, and
wherein the prevention portion is the contact portion, whose peripheral edge portion near an open end of the slit is curved in a direction in which the peripheral edge portion approaches the front cabinet.

8. The liquid crystal display apparatus according to claim 7,
wherein a boss stands on a peripheral back edge of the liquid crystal display unit,
wherein the fixing device includes a cover portion that is the other side portion thereof, the cover portion covering the peripheral back edge of the liquid crystal display unit, and
wherein the prevention portion is a protrusion that is disposed at an end of the cover portion in a direction along the periphery of the front cabinet so as to protrude toward a back side of the liquid crystal display unit.

9. The liquid crystal display apparatus according to claim 6,
wherein a width of the slit increases toward an open end of the slit.

10. The liquid crystal display apparatus according to claim 8,
wherein the cover portion has a through-hole for fixing the cover portion to the liquid crystal display unit, and
wherein the boss stands at a position corresponding to the through-hole.
